(19) United States
(12) Patent Application Publication
(10) Pub. No.: US 2019/0045055 A1
(43) Pub. Date: Feb. 7, 2019

(54) CALL OBSERVATION SYSTEM USING SIPREC

(71) Applicant: CafeX Communications Inc., New York, NY (US)

(72) Inventors: Gareth David Smith, Bridgend (GB); Kieran John Moore, Cardiff (GB); David Gareth Watts, Merseyside (GB); Terrana Jamie Shaw, Pontypridd (GB); David Martin Bush, Cardiff (GB); Kristian S. Hopkins, North Andover, MA (US)

(73) Assignee: CafeX Communications Inc., New York, NY (US)

(21) Appl. No.: 16/052,350

(22) Filed: Aug. 1, 2018

Related U.S. Application Data
(60) Provisional application No. 62/540,298, filed on Aug. 2, 2017.

(51) Int. Cl. H04M 3/42; H04L 29/06; H04M 7/00; H04M 3/51

(52) U.S. Cl. CPC H04M 3/42221; H04L 65/1006; H04M 3/5183; H04M 7/0012; H04L 65/1069

(57) ABSTRACT

According to one example, a system includes one or more memory units configured to store one or more instructions, and one or more processors coupled to the memory units. The processors are configured, upon executing the one or more instructions, to receive, based on one or more Session Initiation Protocol Recording (SIPREC) messages, media associated with a communication session between a caller and a call recipient. The processors are further configured to transmit, in real-time to a third party, the media associated with the communication session between the caller and the call recipient.

### CROSS-REFERENCE TO RELATED APPLICATIONS

This application claims priority to U.S. Provisional Patent Application No. 62/540,298 filed Aug. 2, 2017, the entirety of which is incorporated herein by reference.

### TECHNICAL FIELD

This disclosure relates generally to the field of contact centers and more specifically to a call observation system using Session Initiation Protocol Recording (SIPREC).

### BACKGROUND

Traditionally, when a customer calls into a call center in order to receive assistance, the call may be recorded for later use. Also, during the call, one or more supervisors may join the call in order to assist the customer. These traditional methods for recording and/or joining the call, however, may be deficient.

### SUMMARY

According to one example, a system includes one or more memory units configured to store one or more instructions, and one or more processors coupled to the memory units. The processors are configured, upon executing the one or more instructions, to receive, based on one or more Session Initiation Protocol Recording (SIPREC) messages, media associated with a communication session between a caller and a call recipient. The processors are further configured to transmit, in real-time to a third party, the media associated with the communication session between the caller and the call recipient.

According to another example, a system includes one or more memory units configured to store one or more instructions, and one or more processors coupled to the memory units. The processors are configured, upon executing the one or more instructions, to receive and accept, via one or more Session Initiation Protocol Recording (SIPREC) messages, a call associated with a first communication session between a caller and a call recipient. The acceptance of the call creates a second communication session that is associated with the first communication session. The second communication session is devoid of media associated with the first communication session. The processors are further configured, upon executing the one or more instructions, to receive a request from a third party to receive the media associated with the first communication session, and re-negotiate the second communication session, via one or more additional SIPREC messages, to establish a media stream communication session. The media stream communication session includes the media associated with the first communication session. The processors are also configured, upon executing the one or more instructions, to transmit, in real-time to the third party, the media associated with the first communication session.

### BRIEF DESCRIPTION OF THE FIGURES

For a more complete understanding of the present disclosure and its features and advantages, reference is now made to the following description, taken in conjunction with the accompanying drawings, in which:

FIGS. 1A-1B illustrate an example communication system that may allow a third-party to observe a communication session between a caller and a call recipient, in real-time.

FIG. 2 illustrates another example communication system that may allow a third-party to observe a communication session between a caller and a call recipient, in real-time.

### DETAILED DESCRIPTION

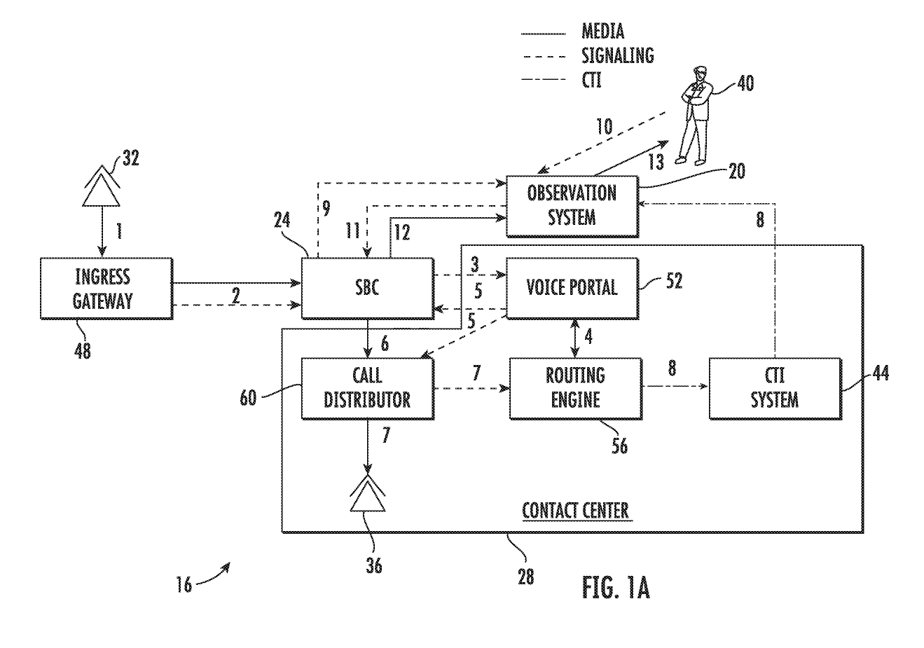

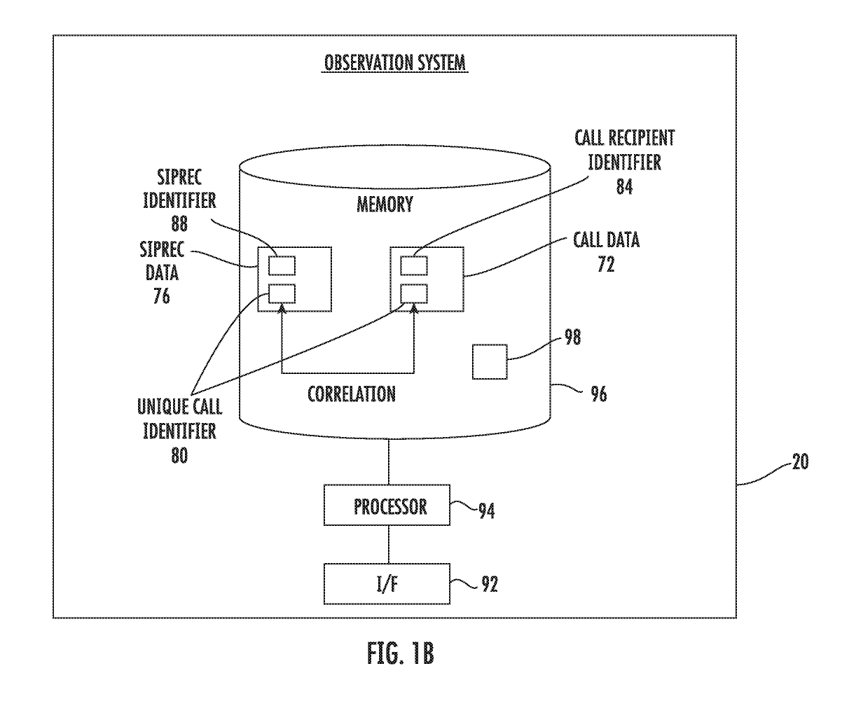

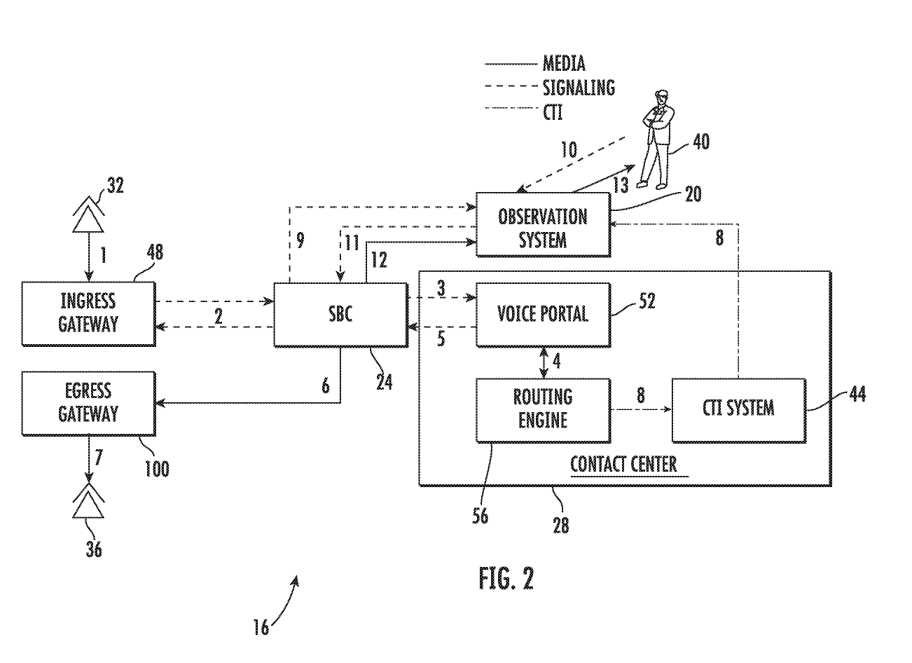

Embodiments of the present disclosure are best understood by referring to FIGS. 1A-2 of the drawings, like numerals being used for like and corresponding parts of the various drawings.

Traditionally, when a customer calls into a call center in order to receive assistance, the call may be recorded for later use. Also, during the call, one or more supervisors may join the call in order to assist the customer. These traditional methods for recording and/or joining the call, however, may be deficient. For example, call center calls are traditionally recorded using the SIPREC standard. Although this standard may allow the call to be recorded, the traditional technological set-up for SIPREC may only allow that recording to be accessible (e.g., listened to, viewed) after the fact. As such, a supervisor or other call center agent may not be able to observe the call in real-time. As another example, allowing other people (e.g., supervisors and or other agents) to join a call with a customer may not be possible (or even desirable). In some examples, the communication system 16 of FIGS. 1A-2 may address one or more of these deficiencies.

FIGS. 1A-1B illustrate an example communication system 16 that may allow a third-party (e.g., a supervisor) to observe a communication session between a caller and a call recipient, in real-time. As is illustrated, the communication system 16 includes an observation system 20 communicatively coupled to a Session Border Controller (SBC) 24, and a contact center 28 communicatively coupled to the SBC 24. In some examples, when a call from a caller 32 is received at the SBC 24, the SBC 24 may interact with the contact center 28 in order to establish a communication session between the caller 32 and a call recipient 36 (e.g., an agent or employee at the contact center 28). This communication session may include media (e.g., audio and/or video) that allows the caller 32 and call recipient 36 to communicate with each other. If a third party 40 (e.g., a supervisor) desires to observe this communication session, the third party 40 may transmit a media request to the observation system 20. Then, based on one or more SIPREC messages, the media may be transmitted to the observation system 20, which may then be transmitted to the third party 40. This may allow the third party 40 to observe the media in real time (and on-demand).

Observation system 20 represents any suitable components that may allow a third party 40 (e.g., a supervisor) to observe a communication session between a caller 32 and a call recipient 36. Observation system 20 may include a network server, any suitable remote server, a mainframe, a host computer, a workstation, a web server, a personal computer, a file server, or any other suitable device that may allow a third party 40 to observe a communication session between a caller 32 and a call recipient 36. The functions of observation system 20 may be performed by any suitable combination of one or more servers or other components at one or more locations. In the example where the observation system 20 is a server, the server may be a private server, and the server may be a virtual or physical server. The server may include one or more servers at the same or remote locations. Also, observation system 20 may include any suitable component that functions as a server. Observation system 20 may include a network interface, one or more processors, and a memory unit, each of which is discussed in further detail with regard to FIG. 1B.

Observation system 20 may operate in accordance with the SIPREC standard. The SIPREC standard is a protocol for call recording that is based on Session Initiation Protocol (SIP). It is typically used for interactions between a SIPREC client (e.g., a session recording client) and a SIPREC server (e.g., a session recording server). In some examples, the observation system 20 may replace (or otherwise operate as) as the SIPREC server that interacts with the SIPREC client using the SIPREC standard. This may allow the observation system 20 to acquire media (e.g., voice, video, etc.) from a SIPREC client (e.g., the SBC 24 or any other SIPREC client).

SBC 24 represents any suitable components that may interact with the contact center 28 in order to establish a communication session between a caller 32 and a call recipient 36. The SBC 24 may provide security, interoperability, routing and other functions in a SIP network, or other VoIP network. In some examples, the SBC 24 may control signaling associated with a communication session, and may further control media associated with the communication session. The SBC 24 may set up, conduct, and tear down communication sessions. Examples of the SBC 24 may include the Cisco Unified Border Element (CUBE), the Avaya Session Border Controller, any other session border controller (including virtual session border controllers), or any combination of the preceding.

The SBC 24 may operate as a SIPREC client. Thus, the SBC 24 may interact with the observation system 20 in accordance with the SIPREC standard. In doing so, the SBC 24 may transmit one or more SIPREC messages to the observation system 20 and/or may receive one or more SIPREC messages from the observation system 20. These SIPREC messages may allow the SBC 24 and the observation system 20 to set up (and continue) a SIPREC communication session between the SBC 24 and the observation system 20. These SIPREC messages may refer to messages (e.g., SIP messages) that set up the SIPREC communication session, and/or they may refer to the SIPREC communication session (itself). The SIPREC messages may be used to set up a media stream communication session that provides media (from a communication session between the caller 32 and the call recipient 36) to the observation system 20, which may then provide this media to the third party 40, in real-time.

Although the SBC 24 is described above in one example as a session border controller, the SBC 24 may be (or its functions may be performed by) any other device that may operate as a SIPREC client. As an example, the SBC 24 may be a call controller that operates as a SIPREC client.

Contact center 28 represents any suitable components that receive and/or transmit calls (e.g., telephone calls, video calls, etc.) so as to establish a communication session. A contact center 28 may be an example of a call center (e.g., it may establish communication sessions using telephone calls). The contact center 28, however, is not limited to just telephone calls. It may also receive and/or transmit video calls (and/or any other call) to establish a communication session.

The contact center 28 may include one or more call agents (e.g., employees of the contact center 28) that may receive such calls and/or make such calls. In some examples, a customer may call into the contact center 28 in order to receive assistance. In other examples, a call agent may call out of the contact center 28 in order to sell a product/service, or otherwise communicate with a customer (or potential customer). The contact center 28 may be associated with a corporation. For example, the contact center 28 may be a contact center for Sony Corporation, Best Buy, Walmart. AT&T, or any other corporation. In order to establish a communication session (e.g., a call that has been placed and accepted by a call recipient 36), the contact center 28 may include one or more elements (e.g., a voice portal 52, a routing engine 56, a call distributor 60, one or more call recipients 36, a CTI system 44, and/or any other elements), each of which is discussed below.

The communication system 16 may include the CTI system 44. The CTI system 44 may represent any components that may allow interactions between the contact center 28 and the observation system 20. The CTI system 44 may be a computer-telephone integration (CTI) system that allows interaction between telephones and computers.

The communication system 16 may also include the caller 32, the call recipient 36, and the third party 40. The caller 32 may represent any person or device that may place a call to the contact center 28. As an example, the caller 32 may be a customer of AT&T, who is calling into the contact center 28 in order to ask questions about a recent bill from AT&T. The call recipient 36 may represent any person or device that may receive (and accept) a call placed into the contact center 28. As an example, the call recipient 36 may be a contact center agent (e.g., an employee of the contact center 28) who answers the call made by the caller 32. In such an example, the call recipient 36 may be an employee of AT&T, who answers the call from the customer, and provides answers to the customer's question about the recent bill.

The third party 40 may represent any person or device other than the caller 32 and the call recipient 36. As examples, the third party 40 may be another contact center agent, another employee of the corporation associated with the contact center 28, a supervisor of the call recipient 36, a compliance manager, or any other person or device. The third party 40 may desire to observe the communication session between the caller 32 and the call recipient 36. The reason for this observation may be to evaluate the performance of the call recipient 36, receive training, ensure compliance with one or more rules and/or regulations, any other reason, or any combination of the preceding.

In an exemplary embodiment of operation of FIGS. 1A-1B, a caller 32 may place a call to the contact center 28. The placement of this call is illustrated as arrow 1. The call may be any type of call. For example, it may be a telephone call, a video call, a VoIP call, any other call, or any combination of the preceding. As is illustrated, the call is a telephone call made over the public switched telephone network (PSTN).

Once the call is placed by the caller 32, it may be connected to an ingress gateway 48. The ingress gateway 48 may represent any suitable components that may route the call to the SBC 24. In some examples, the ingress gateway 48 may terminate a Time Division Multiplexing (TDM) phone line on one side and implement VoIP on the other side. As such, the SBC 24 may receive a VoIP call instead of a TDM phone call. As is illustrated, the ingress gateway 48 may route (or otherwise transfer) the call to the SBC 24. This routing of the call is illustrated as arrows 2. As can be seen, the routing of the call to the SBC 24 includes signaling associated with the call, and further includes media (e.g., voice, video, etc.) associated with the call.

Following reception of the call, the SBC 24 may communicate (or otherwise interact) with the contact center 28 so that a communication session may be established between the caller 32 and the call recipient 36. The communication session may refer to call that has been received and accepted by the call recipient 36, allowing the caller 32 and call recipient 36 to communicate. The communication session may be established in any way. FIG. 1A illustrates an example of the establishment of a communication session between a caller 32 and a call recipient 36 located in the contact center 28 (e.g., located in-house).

As is illustrated, the SBC 24 may send an INVITE message to voice portal 52. In some examples, the INVITE message may be a SIP INVITE message. The INVITE message is illustrated as arrow 3. The INVITE message may not include any of the media associated with the call. In some examples, the mechanism for sending (or passing) the INVITE message may differ per contact center 28. For example, it may be sent (or passed or transferred) via SIP headers, and may typically be sent through Cisco-GUCID in Cisco environments, and User-To-User in Avaya environments. In some examples, the INVITE message may include a unique call identifier. This unique call identifier may be any identifier that uniquely identifies the call placed by the caller 32. When the call is accepted and the communication session is established, the unique call identifier may uniquely identify the communication session between the caller 32 and the call recipient 36. As is discussed below, this unique call identifier may allow the observation system 20 to correlate a particular communication session with a request made by the third party 40, which may further allow the media associated with the particular communication session to be provided to the third party 40, in real-time. In some examples, the unique call identifier may be generated by the SBC 24. In other examples, the unique call identifier may be generated by the voice portal 52. The SBC 24 may then extract the unique call identifier and pass it to the observation system 20.

Following reception of the INVITE message, the voice portal 52 may communicate with the routing engine 56 to request routing information from the routing engine 56 (e.g., the voice portal 52 may make a route request). Based on this request, the routing engine 56 may select (or otherwise determine) a call recipient 36 to route the call to. The routing engine 56 may determine the call recipient 36 in any manner. In some examples, the routing engine 56 may select the first available agent of the contact center 28 as the call recipient 36, or may select the first available agent having a particular specialty (e.g., Spanish speaking, technology specialist, billing specialist, etc.) as the call recipient 36. The routing engine 56 may then send the routing information for that call recipient 36 back to the voice portal 52. The routing information may identity the call recipient 36 and may also tell the voice portal 52 how to route the call to the call recipient 36. Examples of routing information include the employee number, location (e.g., IP address), routing number, phone number, any other identifying and/or routing information, or any combination of the preceding. The communications between the voice portal 52 and routing engine 56 are illustrated as bi-directional arrow 4. These communications may not include any of the media associated with the call. In some examples, these communications may transmit the unique call identifier to the routing engine 56.

The voice portal 52 may then send an INVITE message to the call distributor 60 and/or may inform the SBC 24 to direct media associated with the call to the call distributor 60. The INVITE message and the informing message are illustrated as arrows 5. Following receipt of the informing message, the SBC 24 may forward the media associated with the call to the call distributor 60 (as is seen by solid arrow 6). The call distributor 60 may then connect the call to the call recipient 36, which (when answered by the call recipient 36) establishes the communication session between the caller 32 and the call recipient 36. This communication session includes media (as is seen by solid arrow 7). The media may refer to audio (e.g., the caller 32 speaking to the call recipient 36, and vice versa) and/or video (e.g., a video of the communication session, such as video of call recipient 36 and/or of the call recipient 36's computer screen). In addition to connecting the call, the call distributor 60 may further inform the routing engine 56 that the call has been connected between the caller 32 and the call recipient 36 (as is illustrated by broken arrow 7).

Following the connection of the call, the routing engine 56 may transmit call data to the CTI system 44. The call data may include any data associated with the call. For example, the call data may include information about the call recipient 36, information about the caller 32, information about the communication session, any other information, or any combination of the preceding. Additionally, the call data may also include the unique call identifier (which was supplied to the contact center 28 by the SBC 24). The call data, however, may not include the media of the communication session.

The CTI system 44 may transmit (or otherwise share) this received call data (including the unique call identifier) to the observation system 20. Upon receiving this call data, the observation system 20 may cache the received call data. The transmission of the call data to the CTI system 44, and then to the observation system 20, is illustrated as dotted arrows 8. These transmissions may occur in accordance with CTI standards.

Also following the connection of the call, the SBC 24 may place a SIPREC call to the observation system 20. This SIPREC call may refer to a call between a SIPREC client and a SIPREC server in accordance with the SIPREC standard. In such an example, the SBC 24 may be operating as the SIPREC client, and the observation system 20 may be operating as the SIPREC server. To place the SIPREC call, the SBC 24 may send a SIPREC invite message to the observation system 20. The invite message may have SIPREC data included in its metadata. This SIPREC data may include the unique call identifier (i.e., the unique identifier for the communication session between the caller 32 and the call recipient 36, discussed above), and may also include a SIPREC identifier. The SIPREC identifier may be any identifier that uniquely identifies the SIPREC call placed by the SBC 24 to the observation system 20. When the SIPREC call is accepted and a SIPREC communication session is established between the SBC 24 and the observation system 20, the SIPREC identifier may uniquely identify the SIPREC communication session.

The observation system 20 may cache the SIPREC data (e.g., the unique identifier and the SIPREC identifier), and may accept the SIPREC call. Acceptance of the SIPREC call may create a SIPREC communication session between the SBC 24 and the observation system 20. The SIPREC call/SIPREC communication session is illustrated as broken arrow 9. The SIPREC communication session may be connected (or may provide a connection) to the original communication session between the caller 32 and the call recipient 36. However, the SIPREC communication session may be a dialog (or other communication session) that does not include any of the media associated with the communication session between the caller 32 and the call recipient 36. That is, this SIPREC communication session may not provide the observation system 20 with any of the audio and/or video of the communication session between the caller 32 and call recipient 36. This may differ from traditional SIPREC calls between a traditional SIPREC client and a traditional SIPREC server. These traditional SIPREC calls include the media, as the traditional SIPREC server is actively recording all of the media for later storage and later access (i.e., non-real-time access).

As is discussed above, the observation system 20 may cache the SIPREC data. As a result, the observation system may have cached (or otherwise stored) the call data associated with the communication session between the caller 32 and the call recipient 36, and may have further cached (or otherwise stored) the SIPREC data. Such caching (or storage) is illustrated in FIG. 1B. This caching may allow the observation system 20 to correlate data for each communication session. For example, since the cached call data (72, in FIG. 1B) and the cached SIPREC data (76) both include the same unique call identifier (80), the observation system 20 may be able to correlate the cached call data 72 to the cached SIPREC data 76. This may allow the observation system 20 to correlate any of the data in the cached call data 72 (such as a call recipient identifier 84, for example) with any of the data in the cached SIPREC data (such as a SIPREC identifier 88). As such, the observation system 20 may be able to determine which SIPREC communication session (between the SBC 24 and the observation system 20) is related to (or connected to) a particular communication session (between the caller 32 and the call recipient 36).

At any time during the communication session between the caller 32 and the call recipient 36, the third party 40 may desire to observe the communication session. To do so, the third party 40 may select (or otherwise identify) a particular communication session on the third party's communication device (e.g., a computer, a Smartphone, a telephone, or any other communication device). This selection may be made on-demand (e.g., it may be made whenever the third party 40 desires to make the selection). As an example of the selection, the third party 40 may click on an icon (or other button) that identifies the particular call recipient 36 (e.g., they may click on an icon named “call agent #3”). This selection may cause the third party's communication device to transmit a media request to the observation system 20. The media request may be any type of request that indicates a desire to receive the media associated with the communication session between the caller 32 and the call recipient 36. In some examples, the media request may be a request to connect to a particular call recipient 36 (e.g., a particular agent, device, extension). The transmission of the media request is illustrated as broken arrow 10.

Upon receiving the media request, the observation system 20 may determine which SIPREC communication session is associated with the request. For example, the media request may include an identifier for a particular call recipient 36 (e.g., it may identify call agent #3). In this example, the observation system 20 may search its cached call data 72 to find a particular call data 72 that has a call recipient identifier 84 that matches the requested call agent #3. Upon finding this match, the observation system 20 may retrieve the unique call identifier 80 included in the matched call data 72, and may use this unique call identifier 84 to search its cached SIPREC data 76 to find the particular SIPREC data 76 that has the matching unique call identifier 84. Upon finding this particular SIPREC data 76, the observation system 20 may retrieve the SIPREC identifier 88 included in the SIPREC data 76.

Using the SIPREC identifier 88, the observation system 20 may communicate with the SBC 24 to renegotiate the SIPREC communication session identified by the SIPREC identifier 88. The renegotiation is illustrated as broken arrow 11. This renegotiation may be performed using one or more SIPREC messages that set-up (or otherwise establish) a media stream communication session between the SBC 24 and the observation system 20. The media stream communication session may include the media associated with the communication session between the caller 32 and the call recipient 36. That is, the media stream communication session may include the audio and/or video of the communication session between the caller 32 and the call recipient 36. As a result, the observation system 20 may now receive the media associated with the communication session between the caller 32 and the call recipient 36. This reception of the media is illustrated as arrow 12. Examples of the media stream communication session include a Real-time Transport Protocol (RTP) communication session, a Secure Real-Time Transport Protocol (SRTP) communication session, any other communication session that can include media, or any combination of the preceding.

Following reception of the media, the observation system 20 may further transmit (or present) the media to the third party 40. This transmission is illustrated as arrow 13. This may result in the third party 40 being able to observe the communication session between the caller 32 and the call recipient 36 in real-time. Real-time may refer to the media being received by the third party 40 within about 2 seconds (but preferably sooner) of it being produced by the caller 32 and/or call recipient 36. That is, if the caller 32 says a word, the caller's voice (speaking that word) may be received within about 2 seconds (but preferably sooner) of it being spoken by the caller 32. Other time frames of real-time may include within 2 seconds, within 1.5 seconds, within 1 second, within 0.5 seconds, within 0.2 seconds, or substantially instantaneous. In some examples, real time may refer to the media being received by the third party 40 at the same time (or substantially the same time) as the other party of the communication session receiving the media (e.g., words spoken by caller 32 may be received by the call recipient 36 and the third party 40 at the same time, or substantially the same time). In some examples, real-time may refer to the media being received by the third party 40 without the media having been previously stored or previously cached at the SIPREC client and/or SIPREC server (as was the case with traditional SIPREC systems). Instead, the media may merely be delayed (if it is even delayed at all) by only minor processing and/or minor transmission delays.

As is discussed above, in some examples, communication system 16 may allow a third-party to observe a communication session between a caller 32 and a call recipient 36, in real-time. This may provide advantages over traditional SIPREC systems, which may only allow a recorded communication session to be accessed after the fact (e.g., after the call is already over).

In some examples, the communication system 16 may allow a third party 40 to observe a communication session between a caller 32 and a call recipient 36, on-demand. That is, any time a communication session is occurring, the third-party can select that communication session, and then begin observing the communication session. This may allow the third party 40 to select from any number of communication sessions occurring simultaneously. For example, if 300 communication sessions are occurring simultaneously, the third party 40 can select a particular one communication session (or more than one communication session) to observe, at any time. It also may allow the third party 40 to observe the communication session without the call recipient 36 knowing or actively giving permission, so as to perform a surprise evaluation of the call recipient 36.

In some examples, the communication system 16 may allow a third party 40 to observe a communication session between a caller 32 and a call recipient 36, regardless of the technology or technologies being used by the contact center 28. For example, the communication system 16 may allow a third party 40 to observe a communication session between a caller 32 and a call recipient 36 if the contact center 28 is a Cisco-based contact center 28 (a contact center using Cisco technology), an Avaya-based contact center 28, any other contact center, or any combination of the preceding. Furthermore, when a contact center 28 uses multiple technologies, the third party 40 may seamlessly observe communication sessions in any of the technologies. For example, the third party 40 may not need to know what technology is being used in order to observe the communication session. Instead, the third party 40 may merely send a media request (arrow 10) in the same way (regardless of which technology is being used for the communication session), and the observation system 20 may correlate the request with the proper SBC 24 (e.g., a Cisco SBC, an Avaya SBC) and/or the proper communication session.

In some examples, the communication system 16 may allow a third party 40 to observe a communication session between a caller 32 and a call recipient 36, without increasing bandwidth needs or requirements within the contact center 28. For example, in order for a third party to join a call, traditional call centers may have required a conference call (or other type of call) between the third party, the caller, and the call recipient. This conference call may have increased the bandwidth needs or requirements inside the contact center 28 and/or with the service provider of the contact center 28. Contrary to this, in some examples, the SIPREC communication session and the media stream communication session may be established by the SBC 24, which may be outside the contact center 28 and/or outside the service provider of the contact center 28. As such, the SIPREC communication session and the media stream communication session may occur (allowing the third party 40 to observe a communication session between a caller 32 and a call recipient 36) without increasing bandwidth needs or requirements within the contact center 28. Thus, the communication system 16 may be more desirable to contact centers 28.

In some examples, the communication system 16 may allow for on-demand audio acquisition in real-time, using a SIPREC architecture based on real-time contextual information from an existing resource (e.g., call state from a contact center 28), allowing this to be correlated with other channels in an existing session (e.g. text chat or desktop share). For example, a contact center 28 supervisor may be able to listen to the audio between a contact center agent and a customer, where the standard media observation access for the contact center 28 is unavailable (e.g. where the Built-in-Bridge feature is unavailable in Unified Contact Center Enterprise (UCCE)/Packaged Contact Center Enterprise (PCCE) environment due to incompatible hardware or remote agents). As another example, subject matter experts located physically and/or logically outside of the contact center 28 may be able to receive the audio channel between a contact center agent and a customer. As a further example, the audio channel (e.g., in the previous examples above) may be combined into a collaboration session with additional channels, correlated by context around the contact center agent and the ongoing call (e.g., text chat or desktop sharing).

In some examples, the communication system 16 may allow a SIPREC session to be made available for immediate action, changing an audit reporting and QA feature into a real-time actionable channel. Further, in some examples, this communication system 16 may allow for real-time observation, and may further allow for on-demand observation in real-time to reduce computation and transmission overhead where not required. In some examples, the communication system 16 may also include a way to correlate multiple different channels through extending context across the various media channels and through a proxy in real-time. In some examples, the communication system 16 may not require storage solutions, retention time guarantees, or the storing and post-correlation of call-related meta-data. The audio may be merged into the active user's active context in real time, for however much or little of the call is required, in some examples.

Modifications, additions, and/or substitutions may be made to the communication system 16, the components of the communication system 16, and/or the functions of the communication system 16 without departing from the scope of the specification. For example, although the contact center 28 is described above as including particular elements for establishing the communication session between the caller 32 and the call recipient 36, the contact center 28 may have more elements, may have fewer elements, or may have any other elements that may allow the communication session to be established. Furthermore, the contact center 28 may include the SBC 24 and/or any other elements of the communication system 16.

As another example, although the SBC 24 is described above as generating and transmitting the unique call identifier to the contact center 28 (broken arrow 3), in some examples, the unique call identifier may be generated by any of the elements in the contact center 28, and then transmitted to the SBC 24 for use.

As a further example, although the communication system 16 is described above as allowing a third party 40 to observe a communication session that was started by a person or device calling into the contact center 28 (e.g., a customer calling the contact center 28), in some examples, the communication system 16 may allow a third party 40 to observe any communication session. For example, it may allow a third party 40 to observe a communication session started by a contact center agent (or other employee) calling a customer (or potential customer).

FIG. 1B illustrates one example of the observation system 20 of the communication system 16. As is illustrated, the observation system 20 includes one or more network interfaces 92, one or more processors 94, and one or more memory units 96.

Network interface 92 represents any suitable device operable to receive information from a network, transmit information through a network, receive information from elements of communication system 16, transmit information to elements of communication system 16, or any combination of the preceding. For example, network interface 92 receives SIPREC calls from SBC 24, so as to establish a SIPREC communication session. As another example, network interface 92 receives call data 72 from CTI system 44. As a further example, network interface 92 receives media requests from the third party 40's communication device, and transmits media to the third party 40's communication device. Network interface 92 represents any port or connection, real or virtual, (including any suitable hardware and/or software, including protocol conversion and data processing capabilities, to communicate through a LAN, MAN, WAN, or other communication system) that allows observation system 20 to exchange information with a SBC 24, CTI system 44, the third party 40's communication device, or other components of communication system 16.

Processor 94 communicatively couples to network interface 92 and memory unit 96, and controls the operation and administration of observation system 20 by processing information received from network interface 92 and memory unit 96. Processor 94 includes any hardware and/or software that operates to control and process information. For example, processor 94 executes an observation system management application 98 to control the operation of observation system 20, such as to allow the third party 40 to observe a communication session between the caller 32 and the call recipient 36. Processor 94 may be a programmable logic device, a digital signal processor (DSP), a microcontroller, a microprocessor, a programmable logic controller (PLC), a controller, a logic circuit, an analog controller, any other processing device or the like, or any combination of the preceding.

Memory unit 96 stores, either permanently or temporarily, data, operational software, or other information for processor 94. Memory unit 96 includes any one or a combination of volatile or non-volatile local or remote devices suitable for storing information. For example, memory unit 96 may include RAM, ROM, magnetic storage devices, optical storage devices, any other suitable information storage device, or any combination of the preceding. While illustrated as including particular information modules, memory unit 96 may include any suitable information for use in the operation of observation system 20.

As illustrated, memory unit 96 includes operation system management application 98, call data 72, and SIPREC data 76. Operation system management application 98 represents any suitable set of instructions, logic, or code embodied in a computer-readable storage medium and operable to facilitate the operation of observation system 20.

Call data 72 refers to the call data discussed above with regard to FIG. 1A. Memory unit 96 may include call data 72 for any number of communication sessions. For example, memory unit 96 may include call data 72 for one communication session, two communication sessions, 10 communication sessions, 100 communication sessions, 1,000 communication sessions, 1 million communication sessions, or any other number of communication sessions. The unique call identifier 80 included in a particular call data 72 may allow a particular communication session between a caller 32 and call recipient 36 to be correlated with a particular SIPREC communication session. Thus, it may allow the SIPREC communication session to be renegotiated to establish a media stream communication session that includes the media of the communication session between the caller 32 and the call recipient 36, and may further allow that media to be provided to the third party 40, so that the third party 40 can observe the communication session, in real-time (and on-demand).

SIPREC data 76 refers to the SIPREC data discussed above with regard to FIG. 1A. Memory unit 96 may include SIPREC data 76 for any number of communication sessions. For example, memory unit 96 may include SIPREC data 76 for one SIPREC communication session, two SIPREC communication sessions, 10 SIPREC communication sessions, 100 SIPREC communication sessions, 1,000 SIPREC communication sessions, 1 million SIPREC communication sessions, or any other number of SIPREC communication sessions. The unique call identifier 80 included in a particular SIPREC data 76 may allow a particular communication session between a caller 32 and call recipient 36 to be correlated with a particular SIPREC communication session, as is discussed above.

The components of communication system 16 may be connected to the observation system 20 via one or more networks (not shown). Each of these networks represents any suitable network operable to facilitate communication between the components of communication system 16. Each of these networks may include any interconnecting system capable of transmitting audio, video, signals, data, messages, or any combination of the preceding. Each of these networks may include all or a portion of a PSTN, a public or private data network, a LAN, a MAN, a WAN, a local, regional, or global communication or computer network, such as the Internet, a SIPREC network, a VoIP network, a wireline or wireless network, an enterprise intranet, or any other suitable communication link, including combinations thereof, operable to facilitate communication between the components.

FIG. 2 illustrates another example communication system 16 that may allow a third-party to observe a communication session between a caller and a call recipient, in real-time. In particular, FIG. 2 illustrates an example of the establishment of a communication session between a caller 32 and a call recipient 36 located outside of the contact center 28 (e.g., located at home).

The communication system 16 of FIG. 2 may be substantially similar to the communication system 16 of FIG. 1A. However, the contact center 28 may have different elements and/or a different call flow for establishing the communication session between the caller 32 and the call recipient 36. Furthermore, the call recipient 36 may be located outside of the contact center 28 (as opposed to inside the contact center 28, as is discussed above with regard to FIG. 1A). The call recipient 36 may be located anywhere outside of the contact center 28. As examples, the call recipient 36 may be working from home, an office outside of the contact center 28, a coffee shop, or any other location outside of the contact center 28 (or outside of the service provider of the contact center 28).

According to the illustrated example, the communication system 16 may include an egress gateway 100. The egress gateway 100 may represent any suitable components that may route the call from the SBC 24 to the call recipient 36. In some examples the egress gateway 100 may terminate a VoIP line on one side, and may implement a TDM phone line on other side. As such, the SBC 24 may transmit a VoIP call to the egress gateway 100, and the egress gateway 100 may transmit a TDM call to the call recipient 36, such as via the PSTN.

The communication system 16 may operate as discussed above with regard to arrows 1-4, for example. Then, following the reception of routing information from the routing engine 56 (arrow 4), the voice portal 52 may inform the SBC 24 to direct media associated with the call to the egress gateway 100. The informing message is illustrated as arrow 5. Following receipt of the informing message, the SBC 24 may forward the media associated with the call to the egress gateway 100 (as is seen by solid arrow 6). The egress gateway 100 may then send the call out (or otherwise connect the call) to the call recipient 36 (e.g., over the PSTN), which (when answered by the call recipient 36) establishes the communication session between the caller 32 and the call recipient 36. This communication session includes media (as is seen by solid arrow 7). The media may refer to audio (e.g., the caller 32 speaking to the call recipient 36, and vice versa) and/or video (e.g., a video of the communication session, such as video of call recipient 36 and/or of the call recipient 36's computer screen).

In addition to connecting the call, the egress gateway 100 may further inform the routing engine 56 that the call has been connected between the caller 32 and the call recipient 36 (not illustrated). Alternatively, the SBC 24 may inform the routing engine 56 (either directly, or indirectly through the voice portal 52) that the call has been connected between the caller 32 and the call recipient 36. Following the connection of the call, the communication system 16 may continue to operate as discussed above with regard to arrows 8-13, for example.

Modifications, additions, and/or substitutions may be made to the communication system 16, the components of the communication system 16, and/or the functions of the communication system 16 without departing from the scope of the specification. For example, the components and functions of the communication system 16 of FIG. 2 may be integrated with the components and functions of the communication system 16 of FIG. 1A. In such an example, the communication system 16 may operate in accordance with FIG. 1A-B when the selected call recipient 36 is located inside of the contact center 28, and the communication system 16 may also operate in accordance with FIG. 2 (and FIG. 1B) when the selected call recipient 36 is located outside of the contact center 28.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification. In this manner, Applicant reserves the right to amend the claims during prosecution to add features as variously described in this specification.

What is claimed is:

1. A system, comprising:
one or more memory units configured to store one or more instructions; and
one or more processors coupled to the memory units and configured, upon executing the one or more instructions, to:
receive and accept, via one or more Session Initiation Protocol Recording (SIPREC) messages, a call associated with a first communication session between a caller and a call recipient, wherein acceptance of the call creates a second communication session that is associated with the first communication session, wherein the second communication session is devoid of media associated with the first communication session;
receive a request from a third party to receive the media associated with the first communication session;
re-negotiate the second communication session, via one or more additional SIPREC messages, to establish a media stream communication session, wherein the media stream communication session includes the media associated with the first communication session;
transmit, in real-time to the third party, the media associated with the first communication session.

2. The system of claim 1, wherein the call is received from a SIPREC client.

3. The system of claim 2, wherein the transmission, in real time to the third party, of the media comprises transmission of the media without the media having been previously stored or cached by the SIPREC client.

4. The system of claim 1, wherein the call is received from a Session Border Controller.

5. The system of claim 1, wherein the media associated with the first communication session comprises audio and/or video associated with the first communication session.

6. The system of claim 1, wherein the first communication session comprises an incoming call from the caller to a call agent at a contact center.

7. The system of claim 1, wherein the first communication session comprises an outgoing call from a call agent at a contact center to the call recipient.

8. The system of claim 1, wherein the request from the third party to receive the media associated with the first communication session comprises an on demand request that identifies a particular call agent at a contact center.

9. A method, comprising:
receiving and accepting, by one or more processors and via one or more Session Initiation Protocol Recording (SIPREC) messages, a call associated with a first communication session between a caller and a call recipient, wherein acceptance of the call creates a second communication session that is associated with the first communication session, wherein the second communication session is devoid of media associated with the first communication session;
receiving, by the one or more processors, a request from a third party to receive the media associated with the first communication session;
re-negotiating the second communication session, by the one or more processors and via one or more additional SIPREC messages to establish a media stream communication session, wherein the media stream communication session includes the media associated with the first communication session;
transmitting, by the one or more processors and in real-time to the third party, the media associated with the first communication session.

10. The method of claim 9, wherein the call is received from a SIPREC client.

11. The method of claim 10, wherein transmitting, by the one or more processors and in real-time to the third party, the media associated with the first communication session comprises transmitting, by the one or more processors, the media without the media having been previously stored or cached by the SIPREC client.

12. The method of claim 9, wherein the call is received from a Session Border Controller.

13. The method of claim 9, wherein the media associated with the first communication session comprises audio and/or video associated with the first communication session.

14. The method of claim 9, wherein the first communication session comprises an incoming call from the caller to a call agent at a contact center.

15. The method of claim 9, wherein the first communication session comprises an outgoing call from a call agent at a contact center to the call recipient.

16. The method of claim 9, wherein the request from the third party to receive the media associated with the first communication session comprises an on demand request that identifies a particular call agent at a contact center.

17. A system, comprising:
one or more memory units configured to store one or more instructions; and
one or more processors coupled to the memory units and configured, upon executing the one or more instructions, to:
receive, based on one or more Session Initiation Protocol Recording (SIPREC) messages, media associated with a communication session between a caller and a call recipient;
transmit, in real-time to a third party, the media associated with the communication session between the caller and the call recipient.

18. The system of claim 17, wherein the reception of the media and the transmission of the media is performed in response to an on-demand selection by the third party to receive the media.

19. The system of claim 17, wherein the media associated with the communication session is received by the one or more processors from a SIPREC client.

20. The system of claim 17, wherein the media associated with the communication session between the caller and the call recipient comprises audio and/or video associated with the communication session between the caller and the call recipient.
